(19) United States
(12) Patent Application Publication
(10) Pub. No.: US 2026/0163814 A1
(43) Pub. Date: Jun. 11, 2026

(54) MACHINE LEARNING MODEL FOR NETWORK OPERATION EVALUATION

(71) Applicant: Stripe Inc., South San Francisco, CA (US)

(72) Inventors: Chiranth Hegde, South San Francisco, CA (US); Stathis Vafeias, South San Francisco, CA (US)

(73) Assignee: Stripe Inc., South San Francisco, CA (US)

(21) Appl. No.: 18/987,969

(22) Filed: Dec. 19, 2024

(30) Foreign Application Priority Data
Dec. 10, 2024 (GR) 000005760

(51) Int. Cl. H04L 41/16

(52) U.S. Cl. CPC H04L 41/16

(57) ABSTRACT

Disclosed herein are system and method for enhancing network operation evaluations using machine learning techniques. One embodiment features a server that processes network operation data from various electronic devices using a foundation machine learning model. The model, trained with categorical, numerical, and counter streaming features, generates embeddings capturing real-time and historical context. The embeddings predict risks or outcomes, such as fraud detection or authorization approval. The server transmits these embeddings to downstream models for specialized analysis. The disclosed modular structure supports real-time fraud prediction and network security assessment while maintaining centralized control.

### CROSS-REFERENCE TO RELATED APPLICATIONS

This application claims priority to Greek Patent App. No. 000005760, filed Dec. 10, 2024, which is incorporated herein by reference in its entirety for all purposes.

### TECHNICAL FIELD

This application relates generally to methods and systems to train and execute customized machine learning models to evaluate network operations.

### BACKGROUND

As networked systems become more complex, the need for advanced evaluation of network operations increases, especially in areas with high operation volumes and significant risks of fraud and security breaches. Recent advancements in artificial intelligence modeling have led to attempts to use machine learning (ML) models for evaluating network operations. However, these conventional ML-based approaches face technical challenges.

For example, traditional ML models are typically trained to evaluate network operations in isolation and lack contextual data due to its voluminous nature. Training ML models with contextual data demands substantial computing resources and time. Additionally, executing an ML model trained with extensive contextual data may require more computing resources and time than desired. In sophisticated interconnected networked systems, delayed evaluations can cause further delays for downstream applications, eliminating the possibility of real-time (or near-real-time) evaluation of various network operations.

Moreover, conventional ML models are generally designed for single-task applications, which increases computational overhead and limits their adaptability across different tasks and computing infrastructures. Single-task ML models cannot be easily integrated with downstream software applications, which is a significant technical problem on its own merit. Accordingly, the conventional ML models require extensive resources to train and deploy, yet they still fall short in accurately identifying complex behaviors within high-volume network operation data. Therefore, conventional ML models trained using traditional methods do not provide the timely and accurate evaluations needed and require high computing resources.

### SUMMARY

For the aforementioned reasons, there is a need for customized ML training paradigms that utilize more contextual data to train the ML model and support various downstream applications, enabling fast and efficient network operation evaluation. There is a need for a new training paradigm to use contextual data without the need to increase computing power/resources.

Conventional ML models typically rely solely on categorical data or have limited integration of numerical data, restricting their ability to capture the nuanced patterns necessary for tasks such as fraud detection and risk assessment in various network operations. Without a sophisticated means to incorporate both (sometimes in real-time) network operation details and historical patterns, these conventional ML models often struggle with accuracy, particularly in detecting sophisticated fraud schemes that require an understanding of contextual relationships over time, such as card testing fraud activity.

The methods and systems discussed herein address the technical disadvantages of conventional ML models by introducing an advanced embedding paradigm that uses a transformer-based model to generate dense, generalized embeddings of network operations. By tokenizing and encoding both categorical and numerical features, the models discussed herein create a rich, compact vector representation that captures not only point-in-time network operation details but also historical patterns within the data. This allows the ML model to use a larger volume of data when evaluating a network operation, leading to more accurate results. Moreover, the embeddings discussed herein enable the ML model to be executed with less computing resources and in less time than conventional ML models. Therefore, the methods discussed herein improve conventional ML models in at least two different ways. First, using the methods discussed herein can allow for a ML model (or a suite of ML models) to be executed faster. Second, using the methods discussed herein, the suite of ML models can be executed such that it uses more contextual data than conventional ML models but without increasing the computing resources needed.

The embedding paradigms discussed herein can serve as a foundational layer for various downstream tasks, such as fraud detection, authorization prediction, and card testing, enabling other interconnected machine learning models to analyze transaction data with greater precision and efficiency. For instance, one ML model can generate an embedding that is then ingested by a secondary ML model, where the embedding can be used in conjunction with the secondary ML model's training to predict possible unauthorized access. Therefore, the embeddings discussed herein can improve network security by integrating another ML model into an existing infrastructure. Additionally, the pre-trained embedding layer can reduce the need to train separate ML models, significantly lowering computational requirements and accelerating deployment. This makes the system scalable across a range of applications, from fraud detection to authorization predictions.

The embeddings discussed herein can also be fine-tuned for specific applications, allowing them to support diverse ML tasks with minimal retraining. This adaptability can increase accuracy and consistency across different ML models and within an interconnected suite of ML models.

In some aspects, the techniques described herein relate to a method for configuring a machine learning model, including: receiving, by at least one processor, a status of a network operation; receiving, by the at least one processor, network operation data including a categorical feature and a numerical feature, the categorical features including descriptive information associated with the network operation and the numerical feature including one or more quantitative event metrics; tokenizing, by the at least one processor, the network operation data by converting the categorical feature into one or more tokens; training, by the at least one processor, a machine learning model using a training dataset generated by: obfuscating at least a portion of the tokenized network operation data, and vectorizing the tokenized network operation data and the network operation status, wherein the machine learning model is trained to predict the obfuscated tokens within the training dataset based on one or more of other tokens within the training dataset; receiving, by the at least one processor, a request for an execution of a new network operation; executing, by the at least one processor, the machine learning model using data associated with the new network operation to generate a predicted vector for the new network operation; and transmitting, by the at least one processor, the vector to a downstream computer model configured to block fraudulent network activity.

In some aspects, the techniques described herein relate to a method, wherein the tokenizing is performed in accordance with a frequency of occurrence of one or more terms within the descriptive information.

In some aspects, the techniques described herein relate to a method, wherein the tokenizing is performed by limiting a numerical feature into a predefined length.

In some aspects, the techniques described herein relate to a method, further including: adding, by the at least one processor, a null value for at least one categorical or numerical feature within the network operation data.

In some aspects, the techniques described herein relate to a method, further including: fine-tuning, by the at least one processor, the machine learning model for a specific category of fraud.

In some aspects, the techniques described herein relate to a method, wherein the machine learning model is trained to predict the obfuscated tokens within the training dataset based a position of the obfuscated token within the training dataset.

In some aspects, the techniques described herein relate to a method, wherein the at least one processor obfuscates the at least a portion of the tokenized network operation data based on a relative position of the at least one portion of the tokenized network operation data.

In some aspects, the techniques described herein relate to a system including a computer readable medium configured to store non-transitory instructions, that when executed, cause at least one processor to: receive a status of a network operation; receive network operation data including a categorical feature and a numerical feature, the categorical features including descriptive information associated with the network operation and the numerical feature including one or more quantitative event metrics; tokenize the network operation data by converting the categorical feature into one or more tokens; train a machine learning model using a training dataset generated by: obfuscating at least a portion of the tokenized network operation data, and vectorizing the tokenized network operation data and the network operation status, wherein the machine learning model is trained to predict the obfuscated tokens within the training dataset based on one or more of other tokens within the training dataset; receive a request for an execution of a new network operation; execute the machine learning model using data associated with the new network operation to generate a predicted vector for the new network operation; and transmit the vector to a downstream computer model configured to block fraudulent network activity.

In some aspects, the techniques described herein relate to a system, wherein the tokenizing is performed in accordance with a frequency of occurrence of one or more terms within the descriptive information.

In some aspects, the techniques described herein relate to a system, wherein the tokenizing is performed by limiting a numerical feature into a predefined length.

In some aspects, the techniques described herein relate to a system, wherein the instructions further cause the at least one processor to add a null value for at least one categorical or numerical feature within the network operation data.

In some aspects, the techniques described herein relate to a system, wherein the instructions further cause the at least one processor to fine-tune the machine learning model for a specific category of fraud.

In some aspects, the techniques described herein relate to a system, wherein the machine learning model is trained to predict the obfuscated tokens within the training dataset based a position of the obfuscated token within the training dataset.

In some aspects, the techniques described herein relate to a system, wherein the at least one processor obfuscates the at least a portion of the tokenized network operation data based on a relative position of the at least one portion of the tokenized network operation data.

In some aspects, the techniques described herein relate to a system including: a machine learning model configured to evaluate network activity; a downstream computer model configured to block fraudulent network activity; and a server, in communication with the machine learning model and the downstream computer model, the server configured to: receive a status of a network operation; receive network operation data including a categorical feature and a numerical feature, the categorical features including descriptive information associated with the network operation and the numerical feature including one or more quantitative event metrics; tokenize the network operation data by converting the categorical feature into one or more tokens; train the machine learning model using a training dataset generated by: obfuscating at least a portion of the tokenized network operation data, and vectorizing the tokenized network operation data and the network operation status, wherein the machine learning model is trained to predict the obfuscated tokens within the training dataset based on one or more of other tokens within the training dataset; receive a request for an execution of a new network operation; execute the machine learning model using data associated with the new network operation to generate a predicted vector for the new network operation; and transmit the vector to the downstream computer model.

In some aspects, the techniques described herein relate to a system, wherein the tokenizing is performed in accordance with a frequency of occurrence of one or more terms within the descriptive information.

In some aspects, the techniques described herein relate to a system, wherein the tokenizing is performed by limiting a numerical feature into a predefined length.

In some aspects, the techniques described herein relate to a system, wherein the server is further configured to add a null value for at least one categorical or numerical feature within the network operation data.

In some aspects, the techniques described herein relate to a system, wherein the server is further configured to fine-tune the machine learning model for a specific category of fraud.

In some aspects, the techniques described herein relate to a system, wherein the machine learning model is trained to predict the obfuscated tokens within the training dataset based a position of the obfuscated token within the training dataset.

### BRIEF DESCRIPTION OF THE DRAWINGS

The accompanying drawings constitute a part of this specification and illustrate embodiments of the subject matter disclosed herein.

FIG. 1 illustrates various components of an example of a system for evaluating network operations, according to an embodiment.

FIG. 2 illustrates a block diagram of a method of using a suite of machine learning models to evaluate network operations, according to one or more embodiments.

FIG. 3A illustrates a block diagram of a method of training a machine learning model to evaluate network operations, according to one or more embodiments.

FIG. 3B illustrates a dataset representing a network operation event, according to an embodiment.

FIG. 3C illustrates a dataset representing a network operation event, according to an embodiment.

FIG. 4 illustrates a block diagram of evaluating one or more network operations using a suite of machine learning models, according to one or more embodiments.

FIG. 5 is a component diagram of an example computing system suitable for use in the various implementations described herein, according to an embodiment.

### DETAILED DESCRIPTION

Reference will now be made to the illustrative embodiments illustrated in the drawings, and specific language will be used here to describe the same. Nevertheless, it will be understood that no limitation of the scope of the claims or this disclosure is intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

The methods and systems discussed herein provide embodiments for processing network operation data using a machine learning model that transforms raw data, including both text-based and numerical features, into a consistent, tokenized format. The data can then be structured with fixed positions and sequences for features, enabling efficient handling by a transformer-based model. In some embodiments, numerical values can be converted into two-token representations, and missing values are replaced with special tokens, ensuring uniformity. A machine learning model can then be trained using a masked learning technique, where portions of the tokenized data are obfuscated, and the model learns to predict the missing tokens based on surrounding context.

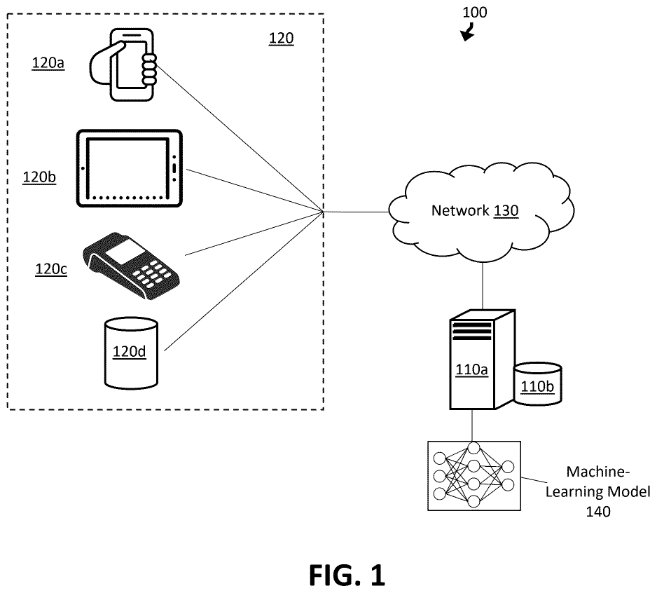

FIG. 1 is a non-limiting example of components of a system 100 that uses machine learning to evaluate network operations. Specifically, in the system 100, a server 110a may utilize features described in FIG. 1 to retrieve and analyze network operations issued by various electronic devices 120a-120d.

The system 100 is not confined to the components described herein and may include additional or other components not shown for brevity, which are to be considered within the scope of the embodiments described herein.

The server 110a may be communicatively coupled to a system database 110b and electronic devices 120a-c (generally referred to as the electronic devices 120. The server 110a may also use various computer models, such as a machine learning model 140 to evaluate network operations requested by the electronic devices 120. As discussed herein, a network operation may be any electronic request causing the server 110a to execute one or more tasks or actions. Non-limiting examples of a network operation may be an API request, an authentication request, an electronic transaction, and the like.

The above-mentioned components may be connected through a network 130. The examples of the network 130 may include, but are not limited to, private or public LAN, WLAN, MAN, WAN, and the Internet. The network 130 may include both wired and wireless communications according to one or more standards and/or via one or more transport mediums. Communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, e.g., a GSM (Global System for Mobile Communications), CDMA (Code Division Multiple Access), and/or EDGE (Enhanced Data for Global Evolution) network.

The server 110a may be any computing device comprising one or more processors and non-transitory, machine-readable storage capable of executing the various tasks and processes described herein. The server 110a may employ various processors, such as a central processing unit (CPU) and graphics processing unit (GPU), among others. Non-limiting examples of such computing devices may include workstation computers, laptop computers, server computers, and the like. While the system 100 is shown as including a single server 110a, the server 110a may include any number of computing devices operating in a distributed computing environment, such as a cloud environment.

The electronic devices 120 may represent various electronic components that receive, retrieve, and/or access data needed to perform one or more transactions and facilitate authorization of accounts involving payments. Therefore, the electronic devices 120 may include various hardware and software components. For instance, the electronic devices 120 may include various devices used by a user to access an account created by the server 110a (e.g., the platform generated by the server 110a).

In operation, the server 110a may receive, retrieve, or obtain a request for a network operation from the electronic device 120. When the server 110a receives the request for the network operation, the server 110a may transmit the request (along with any enriched data retrieved from the system database 110b) to the machine learning model 140. The machine learning model 140 may then analyze the data and predict whether the network operation is fraudulent. For instance, the machine learning model may determine whether a transaction is faulty, or an API request is issued by a fraudulent computing entity. Based on the prediction of the machine learning model 140, the server 110a may either accept or reject the request received.

Conventional network operation evaluation paradigms use machine learning to evaluate network operations. However, these models are limited to processing network operations as isolated, point-in-time events without any historical context or relationship to prior network operations. This approach is used because adding contextual historical data requires vast computing power and resources, which is undesirable. Therefore, conventional models limit their process to a defined portion of the available data. For instance, in the context of transaction evaluation, conventional models limit their evaluation to a specific transaction request or a particular API call for a transaction. This approach restricts the models' ability to detect patterns or make informed decisions based on past behavior, as they cannot incorporate historical data such as the number of recent declines from the same IP address or user.

The methods and systems discussed herein can improve this technical problem specific to conventional models by providing additional contextual data in the form of embeddings generated by a specially-trained machine learning model. As a result, conventional models' performance can be improved because they can benefit from an additional embedding that includes data needed to generate a more accurate prediction. Moreover, the embeddings discussed herein can be used to access and evaluate historical/contextual data without needing to increase computational resources.

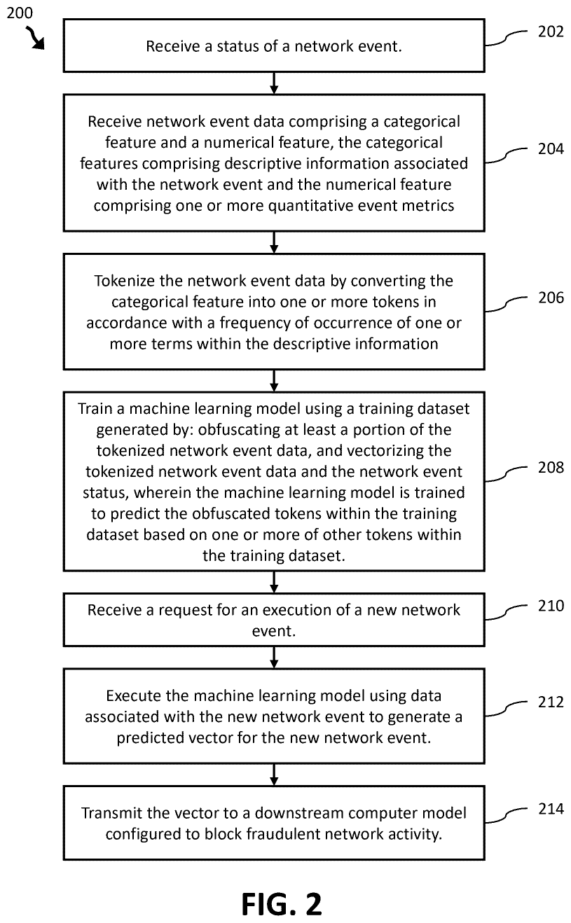

FIG. 2 provides a block diagram of steps in a method 200 that can be implemented to train and execute a machine learning model to generate embeddings that improve conventional ML models. Method 200 describes how integrating various contextual data (e.g., categorical and numerical features) can be used to generate a generalized, pre-trained embedding layer. This layer can serve as a foundational base for various downstream models, minimizing the need to develop separate embeddings. By ingesting the embeddings generated using method 200, a model can produce more accurate predictions in less time and/or using less computing resources. In some embodiments, the method 200 may be executed by a server, such as the server 110a depicted in FIG. 1.

The method 200 may include steps 202-214. In some embodiments, method 200 may include more or fewer steps than those illustrated in FIG. 2. The steps 202-214 of the method 200 may be partially or wholly executed by one or more electronic devices (e.g., servers, user devices, processing circuitry, etc.).

Before implementing the machine learning model, the server may first train the model. The server may use various methods to generate a training dataset suitable for the customized training of the model discussed herein. Specifically, the server may (at steps 202 and 204), the server may retrieve the pertinent data and then preprocess the data as discussed in step 206. After curating the training dataset by executing steps 202-206, the server may then train the model accordingly.

At step 202, the server may receive a status of a network operation. In some embodiments, the server may be configured to query and retrieve a collection of previously executed network operations and the corresponding status of each network operation. For instance, in the non-limiting example of the network operation being an electronic transaction, the server may query one or more databases to receive a list of previous electronic transactions and their corresponding status. In some embodiments, the server may query one or more devices or systems involved in monitoring or processing network activities, such as payment transactions, access requests, or data transfers, to receive the data discussed herein. As used herein, a status may encompass data that reflects the condition, outcome, or progression of a specific network operation. For example, the status could indicate whether a transaction has been successfully authorized, declined, flagged as suspicious (e.g., for secondary review), or otherwise processed (e.g., paid and processed).

At step 204, the server may receive network operation data comprising a categorical feature and a numerical feature, with the categorical features comprising descriptive information associated with the network operation and the numerical feature comprising one or more quantitative event metrics.

The server may query and retrieve additional data associated with the network operation (the operation retrieved in step 202). For instance, the data received in step 202 may include an identifier associated with the network operations. The server may use that identifier to query one or more databases to retrieve additional contextual data associated with each operation. The retrieved data may include both one or more categorical features and one or more numerical features.

As used herein, the categorical features may comprise descriptive information associated with the network operations, providing contextual or identifying details relevant to the event/operation. For example, the categorical feature may include information such as the type of event (e.g., login attempt, transaction, or access request, transaction category), the user or entity associated with the event, or the geographical location from which the event originated. This descriptive information can server to classify or provide context to the network operation, enabling the server to interpret its general nature and use this classification for training purposes.

As used herein, the numerical features may comprise one or more quantitative metrics related to the network operations, providing measurable or statistical data points that contribute to a more detailed analysis of each operation. For example, the numerical features may include metrics such as the frequency of similar events within a defined period, the duration of the event, or the size of the data transfer. These quantitative metrics may allow for more precise evaluation and monitoring, as they offer insight into patterns or anomalies within network activity.

By receiving both categorical and numerical features, the server can perform a more comprehensive analysis of each network operation, combining context with quantitative detail to facilitate tasks such as risk assessment, event classification, and detection of suspicious behavior. In some embodiments, the server may enrich the training dataset (e.g., the retrieved data) by querying and retrieving additional network operation data.

In some embodiments, the server may query and further enrich the training dataset using user-specific data. In some embodiments, user-related information can be valuable contextual information when predicting a pattern of fraud. For instance, a unique user ID or account ID tied to the transaction may allow tracking of a customer's history and patterns. In another example, the server may query geolocation data from the user's IP address and device information (e.g., operating system and device ID); this data can reveal anomalies such as unusual locations or devices that deviate from the user's typical behavior. Moreover, past transaction history, including frequency and typical transaction size, can provide context for identifying whether the current transaction aligns with or diverges from expected behavior.

At step 206, the server may tokenize the network operation data by converting the categorical feature into one or more tokens based on the frequency of occurrence of terms within the descriptive information. The tokenization process may involve desegregating the categorical feature, which includes descriptive data associated with the network operation, into smaller, meaningful units of data, referred to as “tokens.” Each token may then represent a portion of the categorical information, such as individual words, phrases, characters, or sub-words. This tokenization allows the server to process and analyze the categorical feature in a structured format, enabling more efficient training of the machine learning model.

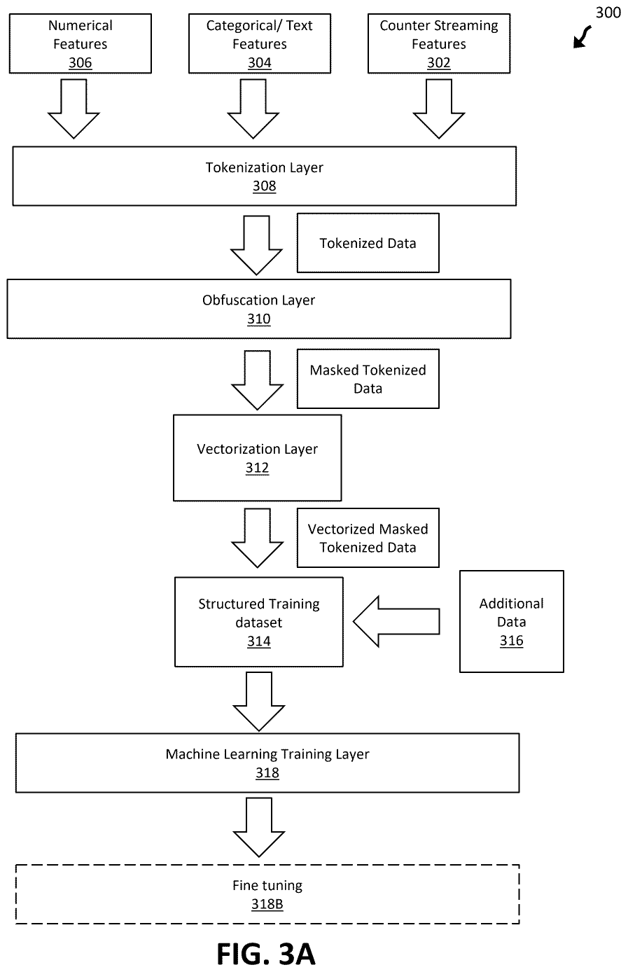

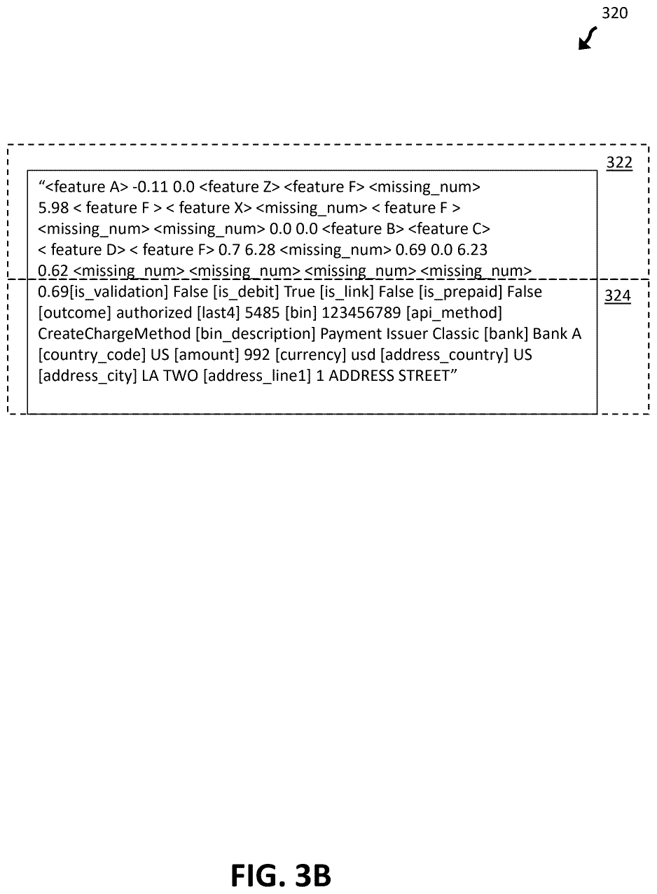

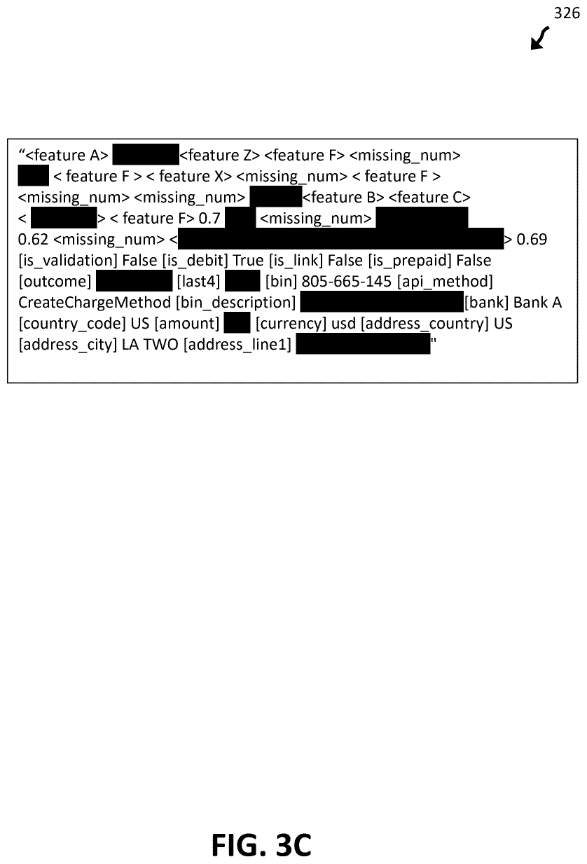

In some embodiments, the server may limit the retrieved data to a predefined length. For instance, the server may select 100 features from the retrieved data. The length (e.g., the number of features) may be preselected and/or defined by a system administrator. In some embodiments, the server may not treat every term/feature equally. To enhance the efficiency and relevance of the tokenization, the server may prioritize terms based on their frequency of occurrence within the dataset as further discussed and depicted in FIGS. 3B and 3C. For example, terms that occur more frequently in the descriptive information may be assigned distinct tokens or be included within the selected list of terms/features. By assigning distinct tokens to certain terms or phrases based on their frequency, the server can capture the significance of these terms within the context of the network operation. In contrast, less frequent terms may be segmented or combined to create a more compact token representation. This approach optimizes computational resources while preserving essential informational content.

In a non-limiting example, the server may retrieve a list of 150 features each designated by one or more terms describing the feature. The server may be preprogrammed to select only 80 of the most occurring (or sometimes predefined) features and the continue with the method 200. By converting the categorical feature into tokens in this manner, the server can leverage common patterns and associations within the descriptive information, facilitating downstream tasks such as model training, data analysis, and predictive modeling for event classification, anomaly detection, or other applications requiring a detailed understanding of categorical data.

In another non-limiting example, the server may receive data associated with a network operation known to be issued by a fraudulent actor. In this example, the network operation is an online transaction. However, this example or any of the methods discussed herein are not limited to online transactions. The server may receive data associated with a credit card transaction flagged for potential fraud. The server then analyzes the transaction's categorical data, such as the merchant ID (e.g., “platform A”), transaction type (e.g., “purchase”), payment method (e.g., “credit card”), and location (e.g., “Washington DC”). To process this information effectively, the server then tokenizes each element of the categorical data by breaking it down into tokens based on common patterns and the frequency of terms across the dataset. For instance, if “platform A” frequently appears as a merchant ID, the server may assign it a distinct token to indicate its common occurrence. This allows for easier data ingestion by a downstream application, such as a machine learning model to be trained. Likewise, common terms like “purchase” and “credit card” would each be assigned tokens that reflect their high frequency. This helps the downstream model quickly recognize and interpret these terms without reprocessing their meanings each time they appear. In contrast, less common terms or merchant IDs, such as “joe's coffee shop,” might be split into smaller tokens or combined with other information to optimize processing. In some embodiments, e.g., if the defined limit has already been achieved, the less important/frequent terms may not be included in the training dataset.

By converting categorical features into tokens in this way, the server creates a structured, tokenized dataset that represents key transaction attributes in a format suitable for training downstream machine learning models. Structuring the data using this method allows for faster training using fewer computing resources, as the machine learning model can detect patterns across similar transactions, identify suspicious activities, and make data-driven inferences more quickly. This tokenization process may also enhance the server's ability to leverage frequently occurring terms and improve its predictive accuracy in real-time fraud detection paradigms. For example, if the system detects an unusual combination of high-frequency tokens like “Washington DC” and “high transaction amount” with a rare merchant ID, it may flag the transaction as potentially risky.

The tokenized features may also include the tokenized numerical features. In some embodiments, the numerical features may also be tokenized using a particular and consistent method, such that the training dataset is ingesting consistent datasets. For instance, the server may first limit the length of the numerical features/metric to a particular defined amount. For instance, the server may limit all numbers to whole numbers and two-digit decimals (11.4567 will be limited to 11.46). The server may then generate two tokens associated with the numerical features where one token includes the number before the decimal point (11) and the second token includes the reduced number after the decimal point (46). As a result, the original number 11.4567 may be tokenized as <11><46>.

The training dataset (each dataset representing a network operation) may maintain the same order and sequence of tokenized features across all entries, ensuring consistent positional encoding and enabling the machine learning model to accurately learn the relationships and contextual dependencies between features. In a non-limiting example, a training dataset for an electronic transaction may include the following tokenized features of transaction amount, user ID, IP address, and timestamp, in that specific order. If one transaction is tokenized as:
[23.45, user123, 192.168.0.1, 2023-11-17T10:30:00]
then every other transaction in the dataset should follow the same sequence of features, such as:
[15.00, user456, 192.168.0.2, 2023-11-17T11:00:00]

This consistency in the relative position of the features may allow the machine learning model to consistently interpret the first token as the transaction amount, the second as the user ID, the third as the IP address, and the fourth as the timestamp, regardless of the specific values in each transaction, as further discussed and depicted in FIGS. 3B and 3C.

At step 208, the server may train a machine learning model using a training dataset generated by obfuscating at least a portion of the tokenized network operation data and vectorizing the tokenized network operation data and the network operation status. The machine learning model may be trained to predict the obfuscated tokens within the training dataset based on one or more other tokens within the training dataset.

The server may train a machine learning model using the training dataset. Before using the training dataset, however, the server may preprocess it using a vectorization and obfuscation protocol. First, the server may obfuscate at least a portion of the tokenized network operation data. As used herein, obfuscating may refer to masking or hiding certain tokens within the data, such that the machine learning model is not aware of the obfuscated content. The obfuscation process may create a predictive challenge for the machine learning model.

Obfuscation of a portion of the data may enhance the training process of the machine learning model by challenging it to predict missing or hidden information based on the context provided by the remaining data. In some embodiments, the server may selectively mask or hide parts of the data within a training dataset to simulate missing information. This technique forces the machine learning model to rely on its understanding of contextual relationships and dependencies between different features within the training dataset. Specifically, the machine learning model must accurately infer the obfuscated elements based on the other non-obfuscated portions. In some embodiments, the relative position of the obfuscated token may be used to predict its value.

In some embodiments, the obfuscation involves randomly selecting certain tokens from the categorical and numerical features within the tokenized dataset and replacing them with a special masked token. The masked token may indicate that the information is missing. Alternatively, the masking of the tokens may entail replacing the tokens with random values, making the information appear incorrect.

The server may utilize various protocols to determine how to obfuscate the tokens within the training dataset. These protocols may be selected based on the type or category of network operation. In some embodiments, a system administrator may predefine the obfuscation protocol. Additionally, or alternatively, the server may use a combination of different protocols.

In a first non-limiting example, the server may use a random obfuscation protocol. In this approach, the server randomly selects a subset of tokens within each data instance for obfuscation.

In a second non-limiting example, the server may use frequency-based obfuscation. In this example, the server chooses to obfuscate tokens based on their frequency of occurrence within the training dataset. For instance, high-frequency tokens (e.g., common descriptors like “purchase” or “login”) may be more likely to be masked than less frequently used tokens.

In a third non-limiting example, the server may use a positional or sequential obfuscation protocol. In this example, the server applies obfuscation to specific positions within the tokenized sequence to train the model on different segments of the data. For example, the server may systematically mask tokens at the beginning, middle, or end of a sequence or every third token.

In a fourth non-limiting example, the server may use feature-specific obfuscation. In this example, the server chooses to obfuscate only certain types of features, such as a predefined category of data. In some embodiments, the server may obfuscate numerical or categorical data, such as masking numerical metrics (e.g., transaction amounts or frequency counts) or masking categorical descriptors (e.g., event type or merchant ID).

After obfuscating various portions of the training dataset, the server may vectorize the obfuscated training dataset. In some embodiments, vectorizing entails converting the tokenized categorical and numerical data (both obfuscated and non-obfuscated), along with the associated status of each network operation, into numerical representations (vectors) that the machine learning model can efficiently ingest. The server may generate fixed-length or dynamic-length vectors based on the data retrieved and preprocessed (e.g., obfuscated), such that the vectors can be ingested by the machine learning model for training purposes.

The vectorization process may allow the machine learning model to mathematically process the tokenized data, where each token is represented as a unique vector that captures its semantic or numerical meaning. In this way, the machine learning model can ingest more contextual data than possible using conventional techniques.

After vectorizing the data, the tokenized network operation data and status may be combined into a structured training dataset that the model can analyze. The tokenization and vectorization process provides the machine learning model with the structured, high-dimensional data it needs to learn from the previously known network operation data to identify patterns within the data and generate accurate predictions in applications like fraud detection, event classification, and anomaly detection.

After the training dataset is preprocessed and structured (e.g., tokenized, obfuscated, and vectorized), the server may use the structured training dataset to train the machine learning model, such that the trained machine learning model is configured to predict the obfuscated tokens within this vectorized data, using the context provided by unmasked tokens and the vectorized event status.

During the training phase, the machine learning model may learn to identify patterns and relationships between tokens, improving its ability to predict the obfuscated elements based on contextual inferences from the unmasked tokens. Through iterative exposure to obfuscated tokens during the training phase, the machine learning model becomes proficient at understanding the underlying patterns and relationships within the data. The machine learning model may also learn from the position of the obfuscated token in relation to the non-obfuscated token.

Using the method 200 to train the machine learning model may enable the machine learning model to analyze real-world scenarios where information may be partially unavailable or incomplete, which is an improvement upon conventional machine learning models. The machine learning model's ability to accurately predict obfuscated tokens in training indicates improved performance in real-world applications, such as identifying anomalies, detecting fraudulent activity, or classifying events, where the model must often make decisions based on incomplete or ambiguous data. This obfuscation-driven training process, therefore, enhances the model's resilience and adaptability to real-world data, which may include imperfections.

At step 210, the server may receive a request to execute a new network operation. After the machine learning model has been trained, it is ready to be implemented to improve network security by evaluating various network operations and events. The server may then receive an indication that another server or processor has requested to execute a network operation. The server may then query and receive operational data associated with the proposed network operation.

For instance, when a customer initiates an online transaction at an online checkout, the processing system may send a request to the server to execute and validate the electronic transaction. This request may contain various details related to the electronic transaction, such as the merchant ID, the transaction amount, the payment method, card information, and the customer's location, device data, and the like. Upon receiving this request, the server may prepare to process and analyze the network operation by evaluating the incoming transaction data and cross-referencing it with historical patterns or known fraud indicators.

At step 212, the server may execute the machine learning model using data associated with the new network operation to generate a predicted vector for the new network operation. The server generates a dataset that represents the new network operation. The server may query and retrieve various datapoints associated with the new network operation and tokenize and generate an ordered sequence of the tokenized data points as discussed herein.

In a non-limiting example, the server may receive a request to evaluate a new transaction. As a result, the server may then retrieve transaction data (e.g., transaction amount, user ID, merchant ID, user historical payment data, merchant historical payment data). The server may then tokenize the retrieved data the same way as was used when training the machine learning model (e.g., the step 206). The server may then place the tokenized values in the same order as it was used to train the machine learning model. As a result, the machine learning model may ingest an input dataset for the new transaction that resembles datasets ingested during training. However, instead of arbitrary obfuscating the values, the machine learning model can use the position and sequence of the missing data (within the ingested input dataset) to predict one or more values associated with the new transaction.

The model, previously trained using the methods discussed herein, can analyze the categorical and numerical data to identify patterns in the transaction data and generate the predicted results/embedding. The predicted embedding/vector serves as a compact, numerical representation of the network operation, capturing patterns and relationships derived from previous training data. The predicted embedding may include contextual data needed for a downstream software application and/or machine learning model to evaluate and generate a likelihood of fraud associated with the network operation.

The prediction of the machine learning model may reflect the specifics and contextual data associated with the network operation. Additionally, the embedding may include data associated with similar network operations within the model's learned representation space, allowing for quick comparison and contextual analysis by the downstream machine learning model(s). By generating the predicted embedding, the server may provide a standardized output that can be further used for downstream analysis, such as detecting anomalies, predicting fraud likelihood, or classifying the event. This embedding may enable efficient and consistent processing, allowing the downstream software applications and/or machine learning models to make informed decisions about the network operation in real-time (or near-real-time).

At step 214, the server may transmit the vector to a downstream computer model configured to block fraudulent network activity. The server may transmit the predicted embedding to a downstream computer model that is configured to analyze the network operation using network operation data in conjunction with the predicted embedding (predicted at the step 112). The downstream machine learning model may be fine-tuned for a particular type of fraud. For instance, the downstream machine learning model may be specifically trained and fine-tuned for card testing fraudulent transactions. In another example, the downstream machine learning model may be specifically trained and fine-tuned for determining whether an in-person transaction is fraudulent.

The downstream application may apply its own training and rules in conjunction with the predicted embedding to evaluate the network operation. Upon receiving the predicted embedding, the downstream model may evaluate it using various techniques, such as anomaly detection, threshold-based scoring, or predictive algorithms, to determine whether the network operation exhibits characteristics commonly associated with fraudulent behavior. If the downstream model determines that the network operation corresponds to a high-risk event, it may block or flag the network operation, thereby preventing potential fraud and increasing network security.

As discussed herein, the methods discussed herein improve the accuracy and the efficiency of the downstream application and/or machine learning models because the downstream applications/models have the advantage of using the predicted embedding that includes contextual data. Therefore, by using the method 200, the downstream application can analyze more data without requiring more time and/or computing resources.

The method 200 can be applied to any network operation and can be used to improve the operational efficiency of machine learning models. In a non-limiting example, the network operation may be an electronic transaction, as depicted and described in FIG. 3A. FIG. 3A illustrates a method 300 for training a machine learning model to analyze electronic transactions, in accordance with an embodiment. Specifically, the method 300 depicts how a server can generate a training dataset using different data streams associated with electronic transactions and how the server can preprocess the data retrieved to train a machine learning model.

The method 300 may start with a server receiving three separate streams of data. In some embodiments, the server may periodically query and retrieve data from one or more databases. For instance, one or more databases of an electronic payment system may be configured to monitor and store transaction data as various transactions are facilitated. This data can then be retrieved by the server to train a machine learning model.

The server may query one or more databases and receive three categories of data associated with previously implemented transactions. Counter streaming features 302, categorical/text features 304, and numerical features 306 represent different types of data input into the training pipeline depicted in FIG. 3A.

The first category of the retrieved data may be counter streaming features 302 that may include dynamic metrics such as the number of declines or transactions over a set period, providing insight into temporal patterns or trends. This feature may refer to time-based or aggregated metrics that provide a summary of specific network operation activity over a defined period. Counter streaming features 302 may capture historical or recurring patterns related to electronic transactions. These features may provide contextual information that helps clarify temporal trends or repetitive behaviors, which can be used to identify patterns or indicators of potential network risk. For example, a high count of recent declines or repeated transactions from the same user or card could signify suspicious activity. Non-limiting examples of counter streaming features 302 may include the number of declined transactions (e.g., the count of declined transactions associated with a particular user, card, or IP address over a defined time period), frequency of login attempts (e.g., the number of login attempts from the same user account or IP address within a defined time period), transaction volume over time (e.g., the count of transactions initiated by a specific user, device, or card over a defined period), and the like.

The second category of data retrieved may include numerical features 306. The numerical features 306 may include quantifiable metrics associated with the electronic transactions. Non-limiting examples of numerical features 306 may include transaction amount (e.g., the exact monetary value of a transaction, such as $150.46), frequency count (e.g., the number of times a particular transaction has occurred within a certain period; for instance, the number of transactions a user has made in the past 24 hours or the number of login attempts from a specific IP address in a week), decline count (e.g., the number of times a specific user, card, or account has had transactions declined within a defined time frame), success ratio (e.g., the ratio of successful transactions to total attempted transactions for a specific user, card, and/or account), time interval between events (e.g., the average or specific time interval between consecutive events, such as the time between two transaction attempts or between two login attempts), historical average transaction amount (e.g., the average amount spent by a user over a defined time period), geolocation distance (e.g., the distance between the current transaction location and the user's previous transaction locations), account age (e.g., the time elapsed since the user account was created), device usage count (e.g., the number of times a specific device or device type has been used by a user within a given period), and the like.

The data retrieved may also include categorical/text features 304. This category of retrieved data may refer to descriptive, non-numeric information associated with various electronic transactions. This data may provide descriptions associated with the nature of the network operation. Non-limiting examples of categorical/text features 304 may include transaction type (e.g., purchase, refund, transfer), user ID or account ID (e.g., a unique identifier for the user involved in the event), merchant ID (e.g., a unique identifier for the business associated with a transaction), payment method (e.g., credit card, debit card, bank transfer, digital wallet), event location (e.g., country, city, or IP geolocation where the event occurred), device type (e.g., mobile, desktop, tablet), event status (e.g., authorized, denied, pending), account type (e.g., personal, business, premium), browser or operating system (e.g., which browser or other electronic platform was used to initiate the transaction), event source (e.g., app, website, API).

After the data has been retrieved, the data (302-306) may be aggregated and tokenized via the tokenization layer 308. The server may process the aggregated data by converting categorical/text features, numerical features, and counter streaming features into tokens that can be interpreted by the machine learning model. For categorical/text features, tokenization involves dividing descriptive information, such as transaction type or user ID, into tokens based on unique terms or meaningful sub-words.

For numerical features, tokenization may involve discretizing or transforming values to fit a predefined vocabulary or a predefined structure. Accordingly, the server may convert numbers into tokens that retain quantitative relationships. Similarly, counter streaming features 302 can be tokenized in a manner that preserves their temporal context. By structuring all input data as tokens (the tokenization layer 308), the server may provide a consistent format for downstream processing, such as training the machine learning model.

In a non-limiting example, the server may convert the data retrieved into a string format using a tokenizing protocol. For instance, the server may train a tokenizer using byte-pair encoding (BPE). This allows the server to ingest an input sequence and convert it into a list of tokens that can eventually be ingested by a machine learning model (e.g., transformer models). For instance, the following input can be received by the server:
“[is validation] False [is_debit] . . . [address_line1]1 ADDRESS STREET”

Using the BPE method, the server may tokenize the string as follows: “[3432, 232, 53, 434, . . . , 783,8374]”

In some embodiments, the server may adjust the data while it is being tokenized to incorporate numerical data into the encoder. For instance, the server may adjust the context length to add additional numerical features. In some embodiments, the server may set a fixed length for the numerical features within the training dataset. For example, the server may limit the number of numerical features to a defined number, such as 100, to create a structured and consistent training dataset.

The structure and placement of different tokens may be consistent throughout to create efficiencies while training the machine learning model. For instance, the server may add the 100 numerical features to the beginning of the sentence that includes the textual data associated with different transactions. In some embodiments, the server may omit adding the numerical feature names. The server may add the 100 feature values one after the other (in some embodiments, the feature values may be separated within the training dataset) before the other transaction data as described and depicted in FIG. 3B (e.g., the first portion 322 being added to the second portion 324).

In some embodiments, the server may only maintain counter and ratio-based features. For instance, the server may transform the counter features and maintain ratios between 0-1. Additionally, the server may limit the value past a defined number of decimals. For instance, 13.451623 may be transformed into 13.45 within the training dataset. After creating a consistent series of numerical values, the server may tokenize the values. In some embodiments, the server may tokenize ratios using two tokens for all numerical features. For instance, 15.235895 may first be transformed into 15.23; subsequently, the 15.23 may be tokenized as <15><0.23>. In another example, 0.99 may be tokenized as <0><0.99>.

In some embodiments, the transaction data received may be incomplete. In those cases, the server may add an indicator (e.g., <missing>) to represent missing numerical transactions. In some configurations, the “missing” indicator may only be applied to numerical features because the server is not representing the feature name for numerical features.

The newly tokenized data can then be added to transaction data. As illustrated, the dataset 320 includes two portions: a first portion (322) that includes the tokenized numerical values that correspond to the features retrieved, and a second portion (324) that corresponds to event data, which is similar to the input data associated with a transaction. As depicted, the server may add the first portion 322 that includes the contextual data to the beginning of the transaction data (represented by the second portion 324). Also as depicted, adding numerical data to existing textual data does not increase the computational resources needed to analyze the network operation.

Referring back to FIG. 3A, after the data has been tokenized, the tokenized data may be obfuscated using the methods discussed herein (obfuscation layer 310). For instance, the server may selectively mask certain tokens within the tokenized dataset, creating partially obfuscated data. Referring now to FIG. 3C, a non-limiting example of an obfuscated dataset is depicted. It should be noted that the obfuscated data 326 is represented as visually redacted for ease of illustration. However, the server may change the obfuscated value within the dataset to a null value instead of redacting the value.

The consistent structure of the training dataset may be achieved by tokenizing all data-categorical, numerical, and counter streaming features-into a uniform format that suits transformer-based models. As discussed herein, numerical values can be split into two tokens (integer and decimal parts) and limited to a fixed decimal precision, while each feature may be assigned a consistent position, ensuring uniformity across entries. Missing numerical data may be represented with special tokens, maintaining a predictable input length, while categorical data allows flexible lengths for text values.

Additionally, the obfuscation layer may mask specific tokens during training, reinforcing structured learning and allowing the model to infer relationships between features. This systematic approach results in a training dataset that is standardized, compact, and efficiently processed by the model.

This consistent training dataset structure may provide various technical advantages by aligning diverse data types (e.g., text, numerical, and temporal) into a standardized tokenized format that's ideal for machine learning models using transformers. By assigning fixed feature positions, using consistent two-token representations for numerical data, and incorporating special tokens for missing values, the machine learning model can gain a predictable and robust input structure, enabling it to learn contextual relationships with greater accuracy and efficiency. This consistent training dataset structure also reduces computational demands by reducing dimensionality.

After the obfuscation, the server may utilize a vectorization layer 312 to transform the tokenized and obfuscated data into dense numerical vectors. In some embodiments, the server may map each token to a vector representation, which encodes semantic or quantitative relationships between features. For categorical/text tokens, the vectorization process may utilize embeddings to map tokens into a high-dimensional space (e.g., similar or related tokens may be positioned close together to reflect their contextual relationship). For instance, for the numerical features 306 and/or the counter streaming features 302, the vectorization may involve normalization or standardization. This ensures that the model can ingest the data mathematically, facilitating efficient computation during model training.

After the training dataset has been vectorized, the server may structure the training dataset (step 314) by combining the vectorized data from multiple features along with any additional contextual data 316 that may be relevant to model training. This structured training dataset serves as the foundational input for training the machine learning model. The structured training dataset may include both obfuscated and non-obfuscated tokens, providing diverse scenarios for the model to learn from. In some embodiments, the additional data 316 may comprise historical event data, risk scores, or external indicators that enhance the training context.

By organizing data into a structured and comprehensive format, the server enables a robust training phase for the machine learning model. Due to the structured nature of the data, the training phase can be performed more efficiently, using less computing power or taking less time.

Once the training dataset has been prepared and processed using the various layers discussed herein, it may be transmitted to a machine learning model in the machine learning training layer 318. In some embodiments, the structured training dataset is used to train one or more machine learning models. During training, the machine learning model may learn to predict the obfuscated tokens within the dataset based on surrounding unmasked tokens and based on their position relative within the structured dataset, thereby reinforcing the model's capacity to infer missing information through contextual understanding. Because all the training data (data associated with different network operations) are consistently structured, the machine learning model can learn how to predict numbers within the same position.

Through this training, the machine learning model may develop a generalized embedding of transaction patterns, equipping it to make accurate predictions in downstream tasks, such as identifying unusual or fraudulent activity, predicting transaction outcomes (e.g., likely approval or decline), and assessing risk levels based on the learned embeddings.

In some embodiments, the server may optionally fine-tune the machine learning model (218B). For instance, after the machine learning model is trained with the obfuscated training dataset to capture general transaction patterns, the model may optionally be fine-tuned to specialize in specific downstream tasks, such as fraud detection, authorization prediction, or dispute forecasting. During fine-tuning, the machine learning model's embeddings may be further adjusted on a labeled dataset that is specific to the desired application.

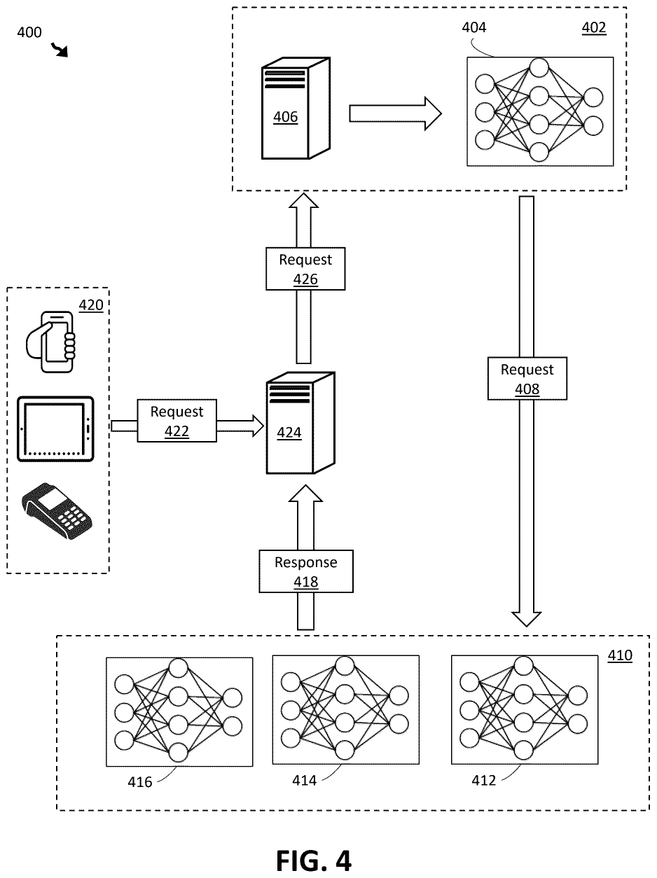

After the model is properly trained, the model can be used in conjunction with other machine learning models, as depicted in FIG. 4. Specifically, FIG. 4 illustrates a system 400 for processing network operations using a suite of interconnected machine learning models.

In the system 400, a user may use a variety of electronic devices 420, such as smartphones, tablets, and point-of-sale terminals, to generate and transmit a request for the server 424 to execute a network operation. For instance, in a non-limiting example, a user may issue a transaction request using an application on a smartphone. As a result, a request 422 may be issued and transmitted to a server of an electronic payment system, such as via an API to the server 424. Before executing the network operation, the server 424 may use various methods to ensure that the network operation does not include fraudulent aspects or any data that could compromise the integrity and the network security of the system 400. Accordingly, the server 424 may serve as a gateway to sensitive resources and data and must ensure the integrity of the system 400.

Conventionally (e.g., a depicted in FIG. 1), the server 424 may transmit a direct request to one or more of the machine learning models 412-416 (collectively the machine learning models 410). As used herein, the machine learning models 410 may represent machine learning models that can analyze the request 422 and determine a likelihood of fraud. However, analyzing the request 422 in isolation may result in inaccurate or incomplete results. Moreover, including additional contextual data may result in delayed response and/or an increase in the computer resources needed.

Instead of directly issuing a request to the machine learning models 410, the server 424 may issue a request 426 to a first layer 402 that includes a server 406 operationally in communication with a foundation machine learning model 404. The machine learning model 404 may be trained and implemented using the methods and systems discussed herein, such as in FIGS. 2 and 3A-C. The request 426 may include a data packet comprising data associated with the request 422, such as an identifier of the user, merchant, transaction information, and the like. Using this data, the server 406 may query for additional contextual data (e.g., historical data associated with the user and the merchant or any other parameter associated with the request 422). The contextual data may then be transmitted to the machine learning model 404.

The machine learning model 404 may be trained using the methods discussed herein, such as method 200. In some embodiments, the machine learning model 404 may be a trained transformer-based architecture that processes network operation data to create generalized embeddings representing the features of the network operation. The machine learning model 404 may analyze and predict possible outcomes or risks associated with the network operation, such as fraud detection or authorization approval.

Once a prediction is generated, the result is returned to the server 406, which may then take further actions based on the output. For instance, the server 406 may issue a request 408 to the downstream machine learning models 410, which are designed to perform specialized analysis or classification tasks based on the embeddings generated by the machine learning model 404. Specifically, the machine learning models 410 may use the predictions by the machine learning model 404 in conjunction with the request 422 (data associated with the transaction, merchant, and the user) to determine a likelihood of fraud. After the prediction, the machine learning models 410 may transmit a response 418 back to the server 424. The response 418 may indicate a likelihood of fraud associated with the request 422. For instance, the response 418 may indicate that the transaction requested by the electronic device 420 is fraudulent. As a result, the server 424 may block the transaction request (request 422).

The modular structure and interconnected nature of the machine learning models in system 400 allow it to adapt to various applications, such as real-time fraud prediction or risk assessment, while maintaining centralized control through a single server.

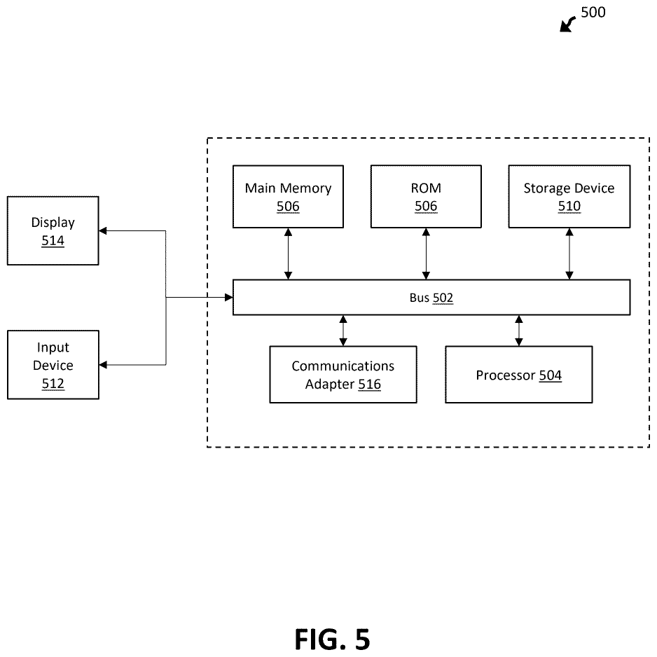

FIG. 5 is a component diagram of an example computing system 500 suitable for use in the various implementations described herein, according to an example embodiment. One or more steps of the methods and processes discussed herein can be performed by the computing system 500 depicted in FIG. 5. The computing system 500 includes a bus 502 or other communication component for communicating information and a processor 504 coupled to the bus 502 for processing information. The computing system 500 also includes main memory 506, such as a RAM or other dynamic storage device, coupled to the bus 502 for storing information, and instructions to be executed by the processor 504. Main memory 506 can also be used for storing position information, temporary variables, or other intermediate information during the execution of instructions by the processor 504. The computing system 500 may further include a ROM 508 or other static storage device coupled to the bus 502 for storing static information and instructions for the processor 504. A storage device 505, such as a solid-state device, magnetic disk, or optical disk, is coupled to the bus 502 for persistently storing information and instructions.

The computing system 500 may be coupled via the bus 502 to a display 514, such as a liquid crystal display, or active-matrix display, for displaying information to a user. An input device 512, such as a keyboard including alphanumeric and other keys, may be coupled to the bus 502 for communicating information, and command selections to the processor 504. In another implementation, the input device 512 has a touchscreen display. The input device 512 can include any type of biometric sensor, or a cursor control, such as a mouse, a trackball, or cursor direction keys, for communicating direction information and command selections to the processor 404 and for controlling cursor movement on the display 514.

In some implementations, the computing system 500 may include a communications adapter 516, such as a networking adapter. Communications adapter 516 may be coupled to bus 502 and may be configured to enable communications with a computing or communications network or other computing systems. In various illustrative implementations, any type of networking configuration may be achieved using communications adapter 516, such as wired (e.g., via Ethernet), wireless (e.g., via Wi-Fi, Bluetooth), satellite (e.g., via GPS) pre-configured, ad-hoc, LAN, WAN, and the like.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a computer-readable non-transitory medium or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method for configuring a machine learning model, comprising:
receiving, by at least one processor, a status of a network operation;
receiving, by the at least one processor, network operation data comprising a categorical feature and a numerical feature, the categorical feature comprising descriptive information associated with the network operation and the numerical feature comprising one or more quantitative event metrics;
tokenizing, by the at least one processor, the network operation data by converting the categorical feature into one or more tokens;
training, by the at least one processor, a machine learning model using a training dataset generated by:
obfuscating at least a portion of the tokenized network operation data, and
vectorizing the tokenized network operation data and status of the network operation,
wherein the machine learning model is trained to predict the obfuscated tokens within the training dataset based on one or more of other tokens within the training dataset;
receiving, by the at least one processor, a request for an execution of a new network operation;
executing, by the at least one processor, the machine learning model using data associated with the new network operation to generate a predicted vector for the new network operation; and
transmitting, by the at least one processor, the predicted vector to a downstream computer model configured to block fraudulent network activity.

2. The method of claim 1, wherein the tokenizing is performed in accordance with a frequency of occurrence of one or more terms within the descriptive information.

3. The method of claim 1, wherein the tokenizing is performed by limiting a numerical feature into a predefined length.

4. The method of claim 1, further comprising:
adding, by the at least one processor, a null value for at least one categorical or numerical feature within the network operation data.

5. The method of claim 1, further comprising:
fine-tuning, by the at least one processor, the machine learning model for a specific category of fraud.

6. The method of claim 1, wherein the machine learning model is trained to predict the obfuscated tokens within the training dataset based a position of the obfuscated token within the training dataset.

7. The method of claim 1, wherein the at least one processor obfuscates the at least a portion of the tokenized network operation data based on a relative position of the at least one portion of the tokenized network operation data.

8. A system comprising a computer readable medium configured to store non-transitory instructions, that when executed, cause at least one processor to:
receive a status of a network operation;
receive network operation data comprising a categorical feature and a numerical feature, the categorical feature comprising descriptive information associated with the network operation and the numerical feature comprising one or more quantitative event metrics;
tokenize the network operation data by converting the categorical feature into one or more tokens;
train a machine learning model using a training dataset generated by:
obfuscating at least a portion of the tokenized network operation data, and
vectorizing the tokenized network operation data and the status of the network operation,
wherein the machine learning model is trained to predict the obfuscated tokens within the training dataset based on one or more of other tokens within the training dataset; receive a request for an execution of a new network operation;
execute the machine learning model using data associated with the new network operation to generate a predicted vector for the new network operation; and
transmit the predicted vector to a downstream computer model configured to block fraudulent network activity.

9. The system of claim 8, wherein the tokenizing is performed in accordance with a frequency of occurrence of one or more terms within the descriptive information.

10. The system of claim 8, wherein the tokenizing is performed by limiting a numerical feature into a predefined length.

11. The system of claim 8, wherein the instructions further cause the at least one processor to add a null value for at least one categorical or numerical feature within the network operation data.

12. The system of claim 8, wherein the instructions further cause the at least one processor to fine-tune the machine learning model for a specific category of fraud.

13. The system of claim 8, wherein the machine learning model is trained to predict the obfuscated tokens within the training dataset based a position of the obfuscated token within the training dataset.

14. The system of claim 8, wherein the at least one processor obfuscates the at least a portion of the tokenized network operation data based on a relative position of the at least one portion of the tokenized network operation data.

15. A system comprising:
a machine learning model configured to evaluate network activity;
a downstream computer model configured to block fraudulent network activity; and
a server, in communication with the machine learning model and the downstream computer model, the server configured to:
receive a status of a network operation;
receive network operation data comprising a categorical feature and a numerical feature, the categorical features comprising descriptive information associated with the network operation and the numerical feature comprising one or more quantitative event metrics;
tokenize the network operation data by converting the categorical feature into one or more tokens;
train the machine learning model using a training dataset generated by:
obfuscating at least a portion of the tokenized network operation data, and vectorizing the tokenized network operation data and the network operation status, wherein the machine learning model is trained to predict the obfuscated tokens within the training dataset based on one or more of other tokens within the training dataset;
receive a request for an execution of a new network operation;
execute the machine learning model using data associated with the new network operation to generate a predicted vector for the new network operation; and
transmit the vector to the downstream computer model.

16. The system of claim 15, wherein the tokenizing is performed in accordance with a frequency of occurrence of one or more terms within the descriptive information.

17. The system of claim 15, wherein the tokenizing is performed by limiting a numerical feature into a predefined length.

18. The system of claim 15, wherein the server is further configured to add a null value for at least one categorical or numerical feature within the network operation data.

19. The system of claim 15, wherein the server is further configured to fine-tune the machine learning model for a specific category of fraud.

20. The system of claim 15, wherein the machine learning model is trained to predict the obfuscated tokens within the training dataset based a position of the obfuscated token within the training dataset.
